(19) United States
(12) Patent Application Publication
(10) Pub. No.: US 2018/0039249 A1
(43) Pub. Date: Feb. 8, 2018

(54) AUTOMATED DYNAMICAL CONTROL OF OPERATIONS AND DESIGN OF PHYSICAL SYSTEMS THROUGH TIME

(71) Applicant: General Electric Company, Schenectady, NY (US)

(72) Inventors: Christopher Donald JOHNSON, Niskayuna, NY (US); Jerrold Allen CLINE, Niskayuna, NY (US); Scott Charles EVANS, Niskayuna, NY (US); Thomas DAVIDSON, Norwalk, CT (US); Steve POULIN, Norwalk, CT (US); Xiaowei LUAN, Norwalk, CT (US)

(21) Appl. No.: 15/226,374

(22) Filed: Aug. 2, 2016

(51) Int. Cl. G05B 19/401; G05B 19/4063

(52) U.S. Cl. CPC G05B 19/401; G05B 19/4063; G05B 2219/32216

(57) ABSTRACT

An installed product includes mechanical components and associated sensors. A computer is programmed with an operational optimization model for the installed product, including modeling of the mechanical components and sensors. The computer is also programmed with a probability estimation model that provides an estimate of a difference measure related to input and output of the installed product. Sensor data is received, which had been generated during operation of the installed product. Output is generated from the operational optimization model based on the received sensor data. Output is generated from the probability estimation model based at least in part on the output from the operational optimization model. At least one installed product component is modified based at least in part on the output from the probability estimation model.

### BACKGROUND

### Technical Field

Embodiments of the invention relate to integrated sensing systems, computer-controlled industrial and mechanical processes and the automated control of capital allocation to achieve one or more desired states of an industrial system at a specified point in time or over a time horizon for performance control of one or more subsystems of the industrial system.

### Discussion of Art

“Digital twin” state estimation modeling of industrial apparatus and/or other mechanically operational entities has been proposed. One example publication is “Digital Twin: Manufacturing Excellence through Virtual Factory Replication” by Dr. Michael Grieves. Dr. Grieves is credited with advancing adoption of the term “digital twin” and advocating for the benefits of this type of modeling. Other proposed applications for use of digital twin modeling include jet engines, locomotives, gas turbines and wind farms. The concept of the “digital twin” is also associated with proposals for the “Internet of Things”. This is due to the installation of numerous sensors in mechanically operational entities to serve as sources of input data for the ongoing modeling and detection of current operational conditions through digital twins.

The use of industrial apparatus in response to the business-physical industrial system which uses the assets whose physical state is being measured, estimated and controlled by the invention can determine the degradation rate and performance with respect to key process indicators (KPI) of the system. “Digital twin operations optimization” (DTOO) controls the design of asset features, the asset allocation to duty assignment and the rate of state change in the many subsystems of an industrial system along with the corresponding stakeholder performance allocations for one or more of the industrial subsystems. The state may be thermodynamic efficiency, remaining life of apparatus or the combined operating capability with respect to the system KPIs. One example publication that describes the KPIs that a digital twin operations optimization control system would automatically and dynamically sense and control is “Creating new value with performance based industrial systems decision and operations management—and engineering opportunity” by Chris Johnson in the National Academy of Engineering's The Bridge, Volume 45, Number 3.

In the prior art, there exist numbers of financial risk and return calculators to assess the cashflows from an existing system or a proposed system. There exist financing vehicles such as on and off balance sheet financing to fund capital projects and there exist contracting infrastructures in which aspects of operating risk are transferred from one party to another. These prior art approaches look to a physical scenario of a system that exists in actual production or on paper as a proposed offering. The fundamental assumption is that the state of the assets in these systems degrade as a function of the operating scenario to which they are exposed.

There is no prior art for an integrated control system which senses physical machine and process parameters, updates state estimations and operating models, solves for performance capability when exposed to exogenous conditions in past, current and scenario based future time intervals in order to virtually sense physical and resulting operational performance and financial ramification whose exposure and cashflows are automatically allocated to the stakeholders in the industrial process whose setpoints are being controlled for. The system concurrently optimizes the design and operations of an existing system, a virtual concurrent system whose alternate designs and operating policies are fully enumerated through past, current and future time, with automated dynamic change to the real and virtual systems so as to cause the states of the assets, subcomponents of the assets and the operating system to dynamically change through time so as to achieve the multiple objectives of one or more financial entities beyond the owners-operators of the physical system and account for the changes in risks and returns with a superstructure that is implemented using cryptocurrency transactions.

The present inventors have now recognized opportunities to provide enhancements to digital twin operations, sensing, modeling and automated dynamical co-optimized control of asset configuration, state and system performance to achieve a targeted economic performance.

### BRIEF DESCRIPTION

In some embodiments, an apparatus is provided for controlling an operational system having mechanical components. The apparatus may include an installed product. The installed product may include a plurality of the mechanical components. At least some of the mechanical components each have at least one sensor associated with and/or installed on the mechanical component. The apparatus further includes a computer programmed with an operational optimization model for the installed product. The operational optimization model performs modeling with respect to at least the mechanical components and the sensors of the installed product. In addition, computer is programmed with a probability estimation model. The probability estimation model provides an estimate of a difference measure related to input and output of the installed product. The apparatus further includes at least one communication channel for supplying sensor data from the sensors to the computer. Still further, the computer includes a processor and a memory in communication with the processor. The memory stores the operational optimization model and the probability estimation model. The memory also stores additional program instructions. The processor is operative with the additional program instructions to receive sensor data generated by the sensors during operation of the installed product. The processor is further operative with the additional program instructions to generate output from the operational optimization model based on the received sensor data. The output from the operational optimization model may be deemed “first model output”. The processor is further operative with the additional program instructions to generate second model output from the probability estimation model based at least in part on the first model output. The processor is further operative with the additional program instructions to modify at least one of the mechanical components of the installed product based at least in part on the second model output.

### BRIEF DESCRIPTION OF THE DRAWINGS

FIG. 1 is a block diagram of an apparatus for performance based industrial systems management (PBISM), according to some embodiments.

FIGS. 2, 2A, 3, 4 and 5 are diagrams that illustrate context, details and objectives for some embodiments of the apparatus of FIG. 1.

FIG. 6 is a flow diagram of an operation according to some embodiments.

FIG. 7 is a block diagram of a computing system according to some embodiments.

### DESCRIPTION

Some embodiments of the invention relate to digital twin modeling. Financial, economic risk and/or pricing modeling are also performed in conjunction with and responsive to outputs from a digital twin. Financial risks and obligations may be allocated among various parties and/or operational modifications to an installed product may be implemented in response to output from the financial, economic risk and/or financial entity models. The digital twin and/or other operational optimization model may include at least one state estimation model for an installed product/asset that dynamically updates physical life consumption and/or operating efficiency and a systems interaction model to calculate one or more KPIs and their interactions.

In ensuing discussion, references to a “digital twin” should be understood to represent one example of a number of different types of operational optimization modeling that may be performed in accordance with teachings of this disclosure.

The term “installed product” should be understood to include any sort of mechanically operational entity, including those referred to in the above section entitled “Discussion of Art”. The term is most usefully applied to large complex systems with many moving parts and numerous sensors installed in the systems. The term “installed” includes integration into physical operations such as the use of engines in an aircraft fleet whose operations are dynamically controlled, a locomotive in connection with railroad operations, or apparatus construction in or as part of an operating plant building.

The term “digital twin” refers to a computer model that virtually represents the state of an installed product, coupled to the installed product with respect to the physical and operating performance into which the disclosed system will dynamically and optimally change the physical-financial state of the installed product, with communication between the installed product and the digital twin via data and information connections. In accordance with existing practices, the digital twin may have respective virtual components that correspond to essentially all physical and operational components of the installed product.

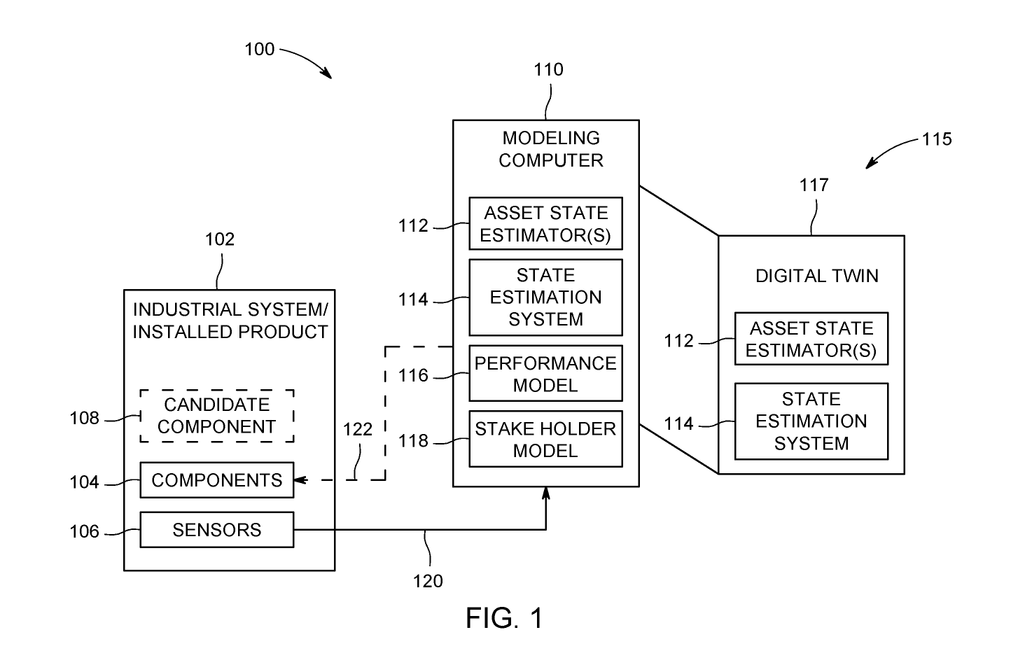

FIG. 1 is a block diagram of a system 100 provided according to some embodiments. The system 100 includes a plant or “installed product” 102. As noted above, the installed product 102 may be, in various embodiments, a complex mechanical entity such as the production line of a factory, a gas-fired electrical generating plant, a jet engine on aircraft amongst a fleet, a wind farm, a locomotive, etc. The installed product 102 may include a considerable (or even very large) number of physical components 104, which for example may include, e.g., turbine blades, fasteners, rotors, bearings, support members, housings, etc., etc. Further, the installed product 102 may include numerous sensors 106. For some types of installed products, the number of sensors may be in excess of 1,000 or even several thousand or many thousands in number. The sensors may be installed on or in association with the physical components 104, perhaps one or more sensors on each discrete physical component or on many but not all of the physical components. The sensors may provide output signals that are indicative of attributes, states, positions, conditions, etc. of the associated physical components. Those who are skilled in the art are aware of the various types of sensors that may be employed in applications of the “Internet of Things”. Some or all of such types of sensors may be employed in particular embodiments. To give just a few examples of the types of sensors, there may be sensors to detect temperature, light, pressure, sound and motion. In addition to sensors that provide data relating to individual physical components, there may be sensors that provide outputs indicative of the environment or overall state of the installed product itself. Such sensors may, for example, indicate ambient air temperature, ambient air pressure, ambient relative humidity, altitude, attitude or velocity in space (for, e.g., transportation-related installed products), etc. It will be apparent that different varieties of sensors may be useful for various types of installed products.

Some sensors are virtual in that, using the state estimation models and the physical sensors that are installed or are caused to be installed, the models are reconciled to infer the pressures, temperatures, flows, work, outputs, variances, contribution to billing, etc., that cannot be directly measured. Other state estimation models may use a virtually derived value in its own state estimation.

The physical-financial system is modelled as that design and operation which exists physically and what may exist (candidate component(s) 108) as directed to be physically or operationally entered into the “as-is” system by the dynamic optimization of the disclosed invention. Further, the modeled system is created in virtual time that includes a physical instantiation of the past, the current design, control and states and multiple future designs, operating control and state estimations. The present invention automatically estimates and controls the states of the system through one or multiple intervals of time to achieve a desired set point and dynamical response to change by changing the design and schedule of assets to duty cycles.

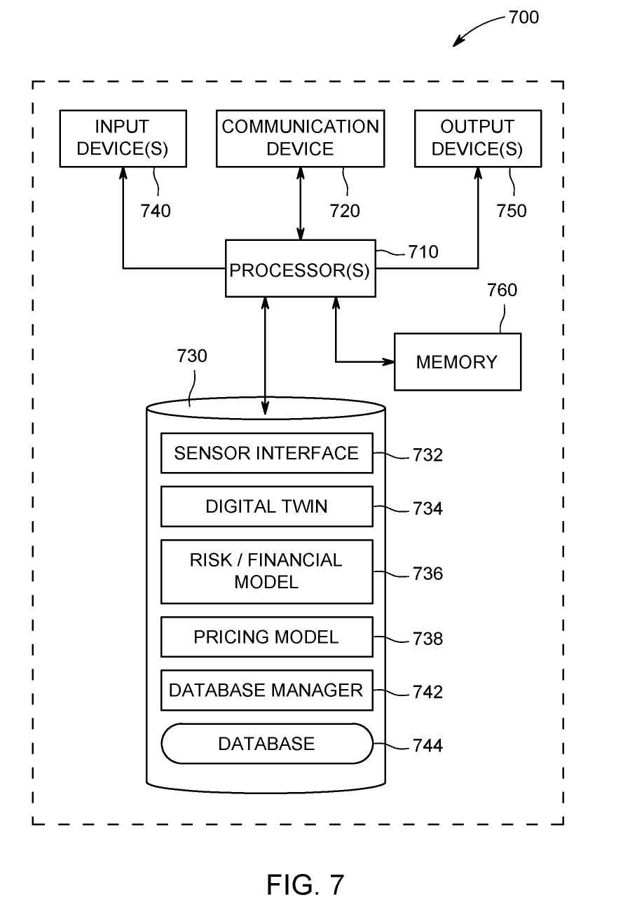

The system 100 also includes a modeling computer 110 configured as the control apparatus. Details of the modeling computer 110 will be described below, including the subsequent discussion of FIG. 7.

The modeling computer 110 may be programmed with one or more asset state estimator modeling software components 112 that model individual components that make up the installed product 102. The modeling computer 110 may further be programmed with a state estimation system software component 114 that provides an overall estimation/simulation of the entire installed product 102. As indicated at 115, the software components 112 and 114 may in some embodiments be instantiated by a digital twin 117 of the installed product 102. The modeling computer 110 may also be programmed with an economic risk/financial model (a/k/a “performance model”) 116 and a financial entity/stakeholder model 118. In some embodiments, the economic risk/financial model 116 and the financial entity model 118 may be combined with each other or may partially overlap or interact with each other. Either or both of the economic risk/financial model 116 and the financial entity model 118 may receive output(s) from the digital twin 117 as input(s) to the processing of the models 116, 118. The performance model 116 may provide modeling as to economic or other performance of the installed product 102. One or more outputs of the performance model 116 may be indicative of a difference measure between input and output of the installed product 102. The difference measure may represent a difference between aggregate input and/or one or more individual inputs, on one hand, and aggregate output and/or one or more individual outputs, on the other hand. The difference measure may be a proxy for or a direct or indirect measure of profitability of the installed product 102. The financial entity model 118 may provide modeling of risk and/or reward arrangements with one or more stakeholders in the installed product 102, with such stakeholders including, e.g., an owner/proprietor/operator, a service/maintenance provider/contractor and one or more investors who directly or indirectly have financial stakes or interests in the installed product or one or more portions thereof pursuant, e.g., to one or more contractual relationships as described below. The modeling computer and computing system, as configured to schedule and control the industrial system, must fully compute the interactions of each component with a time constant of sufficient speed as to react faster than the physical state change being controlled for so as to dynamically change the targeted physical-performance-financial states within the system and thus is designed as an integrated system of hardware, software and performance allocation when running in the instant at real time. When in simulated future time, the system fully solves and allocates performance at each simulation time step and as such must compute the system states and allocations in sufficiently short a time constant as to enable a scenario and its replications to complete and be optimized rapid enough for a human decision maker to assess the current and proposed system control action. As such, the sensors, algorithms, allocation logic and computing systems combined are the integrated modeling computer, so as to achieve the subsecond response time constants of the disclosed system.

A communication channel 120 is included in the system 100 to supply output signals from the sensors 106 as sensor data to the modeling computer 110, particularly as inputs to the processing of the digital twin 117.

In some embodiments, the system 100 may also include a communication channel 122 to supply output from one or more models in the modeling computer 110 as inputs to the installed product 102 or virtualized product components 108. In some embodiments, signals received by the installed product 102 from the modeling computer 110 may cause modification in the state or condition or another attribute or one or more of the physical components 104 of the installed product 102 or its alternate 108.

Although not separately shown in the drawing, one or more control units, processors, computers or the like may be included in the installed product 102 to control operation of the installed product 102, with or without input to the control units, etc. from the modeling computer 110.

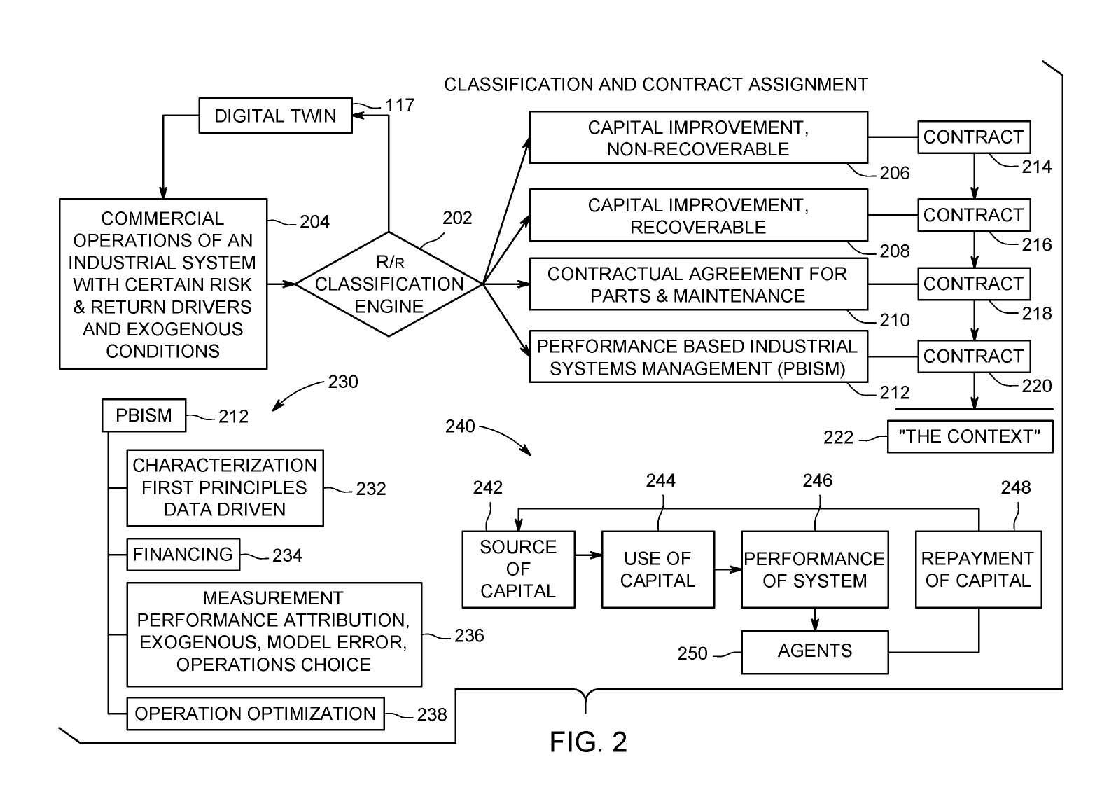

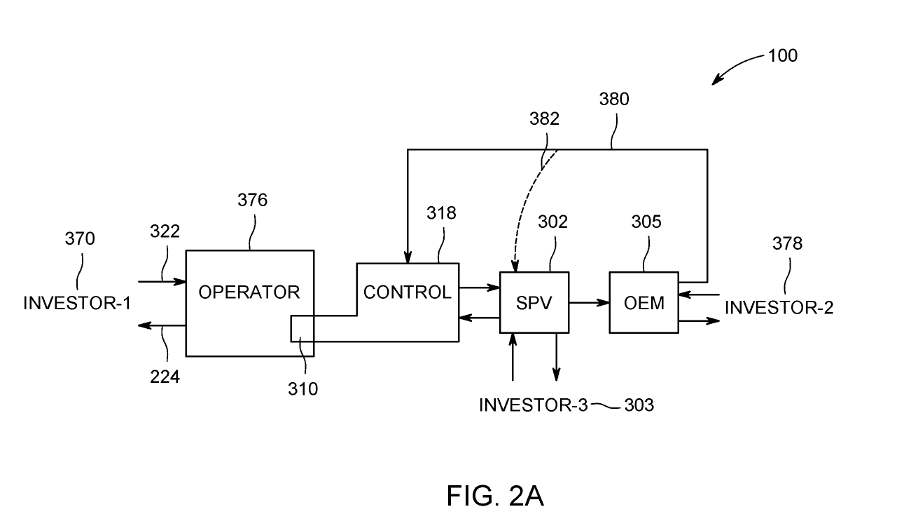

FIGS. 2, 2A, 3, 4 and 5 are diagrams that illustrate context, details and objectives for some embodiments of the system 100 shown in FIG. 1.

Turning first to FIG. 2, this diagram is concerned primarily with classification of expenditures relative to the installed product 102 (FIG. 1) and its virtual alternatives. Continuing to refer to FIG. 2, it is noted that the digital twin 117 is shown again, and receives output from a decision block 202. The decision block 202 may function as a risk/reward classification engine. Output 204 from the digital twin 117 may include operations of the installed product 102 (which may for example be an industrial system of some kind), along with risk and reward drivers and exogenous conditions. The output 204 from the digital twin 117 may be an input to the decision block 202. Possible classification outcomes from the decision block 202 may include a non-recoverable capital improvement (reference numeral 206), a recoverable capital improvement (reference numeral 208), a parts and maintenance contract (reference numeral 210) and a PBISM arrangement (reference numeral 212). Suitable contracts to formalize the outcomes 206, 208, 210 and 212 are respectively indicated at 214, 216, 218 and 220. The contracts 214, 216, 218 and 220, as applicable, may together be said to represent the risk/reward operating context 222 for the system 100.

Attributes of the PBISM arrangement 212 are illustrated at 230. The attributes of the PBISM arrangement include: (block 232) characterization and state estimation of the arrangement and system performance as it exists and for alternative versions of the system which could be caused to exist, including salient principles and data-driven indicators; (block 234) financing terms (including one or more financial entity arrangements for the services provided by the provider of the PBISM-related services); (block 236) measurement aspects of the PBISM arrangement, including performance factors and considerations relating to exogenous factors, model errors and operational decisions; and (block 238) goals related to optimization of operation of the installed product 102.

A generalized framework for the risk/reward classifications 206, 208, 210 and 212 is shown at 240. The various classifications may all include (implicitly or explicitly) provisions for source of capital (block 242), use of capital (block 244), system performance (block 246), and repayment of capital (block 248). The division of roles and responsibilities among “agents” (i.e., parties to one or more of the contracts) is represented at 250. The states of industrial assets, industrial systems, virtual alternatives and financial entities are assessed at block 246 and will be dynamically and optimally controlled by the disclosed system over one or more time intervals.

In some embodiments, at least some aspects of the subject matter illustrated in FIG. 2 may be reflected in the economic risk/financial model 116 and/or the financial entity model 118.

FIG. 2A may be considered to represent the system 100 of FIG. 1 in other aspects, including an emphasis on entities involved in financial relationships relative to the installed product 102 (FIG. 1, not shown in FIG. 2A).

In FIG. 2A, block 376 represents an operator/proprietor of the installed plant. An investor 370 provides investment funding 322 to the operator 376 and receives a cash flow (e.g., return on investment) 324 from the operator 376.

Block 318 represents a control function (which may be physically embodied/represented by the modeling computer 110 shown in FIG. 1). Continuing to refer to FIG. 2A, reference numeral 310 is indicative of a portion of the operations of operator 376 that is controlled by the control function 318. The portion 310 may correspond to the installed product 102 of FIG. 1.

Block 302 represents a “special purpose vehicle”—i.e., a legal entity that may facilitate financing of aspects of the system 100. One or more investors 303 provide investment funding to the SPV 302 and receive a cash flow/return on investment from the SPV 302. Information, signals and/or funding flows in one or both directions between the SPV 302 and the control function 318.

Block 305 represents an OEM/service provider, which may control/support the control function 318 via signal/funding pathway 380. An investor 378 provides investment funding to the OEM 305 and receives a cash flow/return on investment from the OEM 305. Thus the investor may fund some or all of the operations of the OEM 305. OEM 305 also provides information/funding to the SPV 302 via path 382. In addition, funds/information may flow from the SPV 302 to the OEM 305.

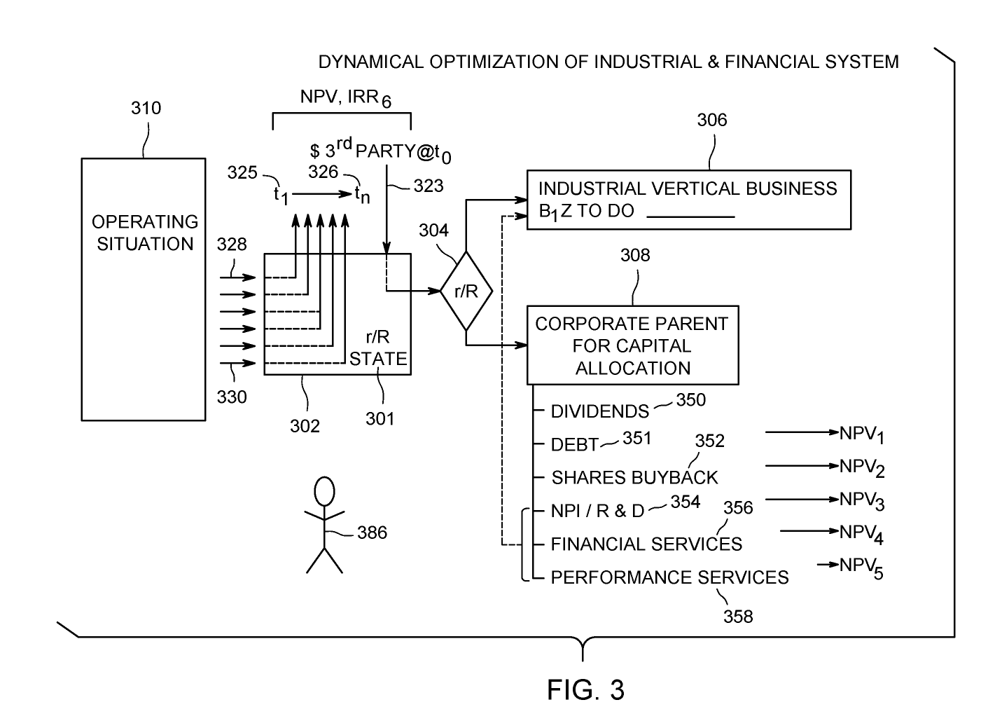

Together with FIG. 2A, FIG. 3 illustrates aspects of the invention which enable the dynamic optimization of the risk/return state of a contractual vehicle at one or more points in time by changing both the physical and contractual design related to the physical system, the financial contract composition with investors and operation of the system.

The discussion will now turn to FIG. 3, which is concerned with capital timing for contractual services. A financial entity 302 schematically is a vehicle for various net present value (NPV) and internal rate of return (IRR) flows at various times. Decision block 304 is indicative of risk/return preferences among various entities.

One or more specific physical design and modification changes to an industrial system are made so as to achieve the operating performance objectives of a contract for at least one owner of the industrial system, at least one service provider and at least one investor. This is achieved by a sensing system which continuously calculates the operating performance of the physical system, compares the operation to that required for achievement of the financial entities' risks and returns according to one or more of the performance based service contracts to manage the industrial system and/or the financial contracts with investors and co-optimizes the physical system's design, and the financial entities' composition of contracts for industrial system improvement.

A financial entity such as a special purpose vehicle or an incorporated operating company 302 (FIGS. 2A and 3) is established to convert cashflows from a present time 328, 325 (FIG. 3) to a series of future flows through time 330, 326. It can be appreciated that this financial entity can process multiple single cashflows in from one party, such as an investor 386 investing in the financial entity 302, providing an original cash flow into the entity at an investment start time 323. Subsequently, additional investments may be made at many times for the future benefits of increased cashflow 324, 326 in the future and that the timings of the entities' inputs and outputs may be at any conceivable temporal and magnitude pattern as agreed to between the stakeholders in the entity, for example between an investor 386 and the entity 302. The effect of the financial entity 302 is to enable one or more third parties 322 to invest into the entity at a first time 323 for the returns associated with a future series of cashflows 324, 326 at an estimated ratio of risk and return 301 being dynamically managed by a controlling service provider 305 (FIG. 2A), which manages the “operating situation” 310 (FIGS. 2A and 3) which includes the industrial system/installed product 102 (FIG. 1). The controlling service provider may be a corporation 308 (FIG. 3) with a capital structure of at least one of stock 350, debt 351, and a share repurchase program 352. The controlling provider may allocate its capital to internal investments in technology and operations 306. Examples of such allocation would be new devices and systems R&D 354, extending financial services such as on and off balance sheet investment 356 and the funding of industrial services 358 such as certain physical repairs and tooling used in the maintenance of industrial systems such as power plants, aircraft, locomotives, medical devices, oil and gas apparatus. The allocation of cash inflows to these investments is made according to the preferences of the controlling provider and their investors 378 (FIG. 2A), subject to first fulfilling the control/contractual obligations 318 of an industrial system performance contract 304 (FIG. 3) which specify a ratio of risk to return and/or a certain cashflow stream. The controlling entity 305 may allocate capital to an operating division 306 to produce products and solutions that enhance industrial systems and/or to the equity owners of the controlling entity 305.

The financial reconciliation and tracking of exposures and value flows resulting from the physical performance of the industrial system may be implemented using an integrated cryptocurrency capacity to settle the exposures at the subsystem and time intervals that the modeling computer is optimizing through. The exposures of stakeholders are themselves a control variable and objective of the optimization capability whose objective may be stationary or adaptive as changed by the stakeholder in response to the system performance in real time or simulated future time.

A dynamical physical-financial system exists between the investors 378 of the controlling entity 305, the performance expected from a special purpose entity 302 where-in those inventors 303 (FIG. 2A) expect a certain return, a service contract 318 with an end industrial customer 376 (FIG. 2A) and the end industrial customer 376 itself and its investors 370. A new investor 386 with capital who is seeking a return may allocate their capital to the end industrial enterprise 376, a service provider 305 or to a financial entity 302. The ratio of risk to return preference of a rational investor 386 would allocate according to that preference, yet the ability to fulfil the expectations may be dramatically different between the three options.

An industrial firm 376 may have limited financial prospects as bound in their competitive market.

A service providing firm 305 using the disclosed system that enables capital investments with participation by others 302 may have significant growth prospects achieved by sensing the operations of industrial assets in many other commercial venues which, with the benefits of the disclosed system, may enter into performance contracts that provide design modifications, operating efficiency investments and ongoing operational decision support, automated control and maintenance services. There may be other investment objectives, for example, by third parties whose core expertise is not operating industrial systems but instead providing financial services for pension trusts, insurance reserves, retirement investments, entities desiring certain cashflow patterns or people desiring higher returns or specified cashflows that a traditional bond or mix of investments cannot otherwise provide. The investment objectives of the third parties may support investments in the disclosed system that generate value (or release “trapped value”), and that would not be supported by the industrial firm or the service provider due to issues such as hurdle rate, cost of capital and/or financial objectives of the industrial firm and the service provider. Such investments may financially benefit all three of the third party investor, the industrial firm and the service provider.

Consider a service providing firm 305 desirous of a capital return 304 at a certain risk level. This firm may provide industrial services to other firms (such as operator 376, FIG. 2A) such as selling equipment as an OEM and then servicing said equipment. Internal to that firm 305, revenues from sales and services are then allocated 308 to their investors 378 or used for product or service development 354, 356, 358 in a particular business division, which has a desirous rate of return that improves the overall risk and return preference 304 of the enterprise. These products and services take a current corporate investment for the hope of a future set of cash flows from commercial activities with customers 380 (FIG. 2A) by virtue of selling goods and services. Another alternative is to divert profits to other business divisions 306 whose prospects of improving the risk and return 304 of the entity 305 dominate a set of opportunities in a first business division. Ideally, all potential investments in products and services could be made that improve the desired ratio risk and return 304 that investors 378 seek. Yet the balance sheets of firms 305 are typically not unlimited. Additional stock may be issued 352 or debt issued 351. The present invention provides an alternative mechanism to expand growth by virtue of a contractual relationship 318 with other firms 376, a sensor and analytical system, a “digital twin” which estimates asset performance and life states and operations KPIs with an operations optimization capability, and a means to enable other investors 303 to provide capital. Other investors may be the end industrial customer 376, an independent investor 303 or the OEM 305 providing performance services.

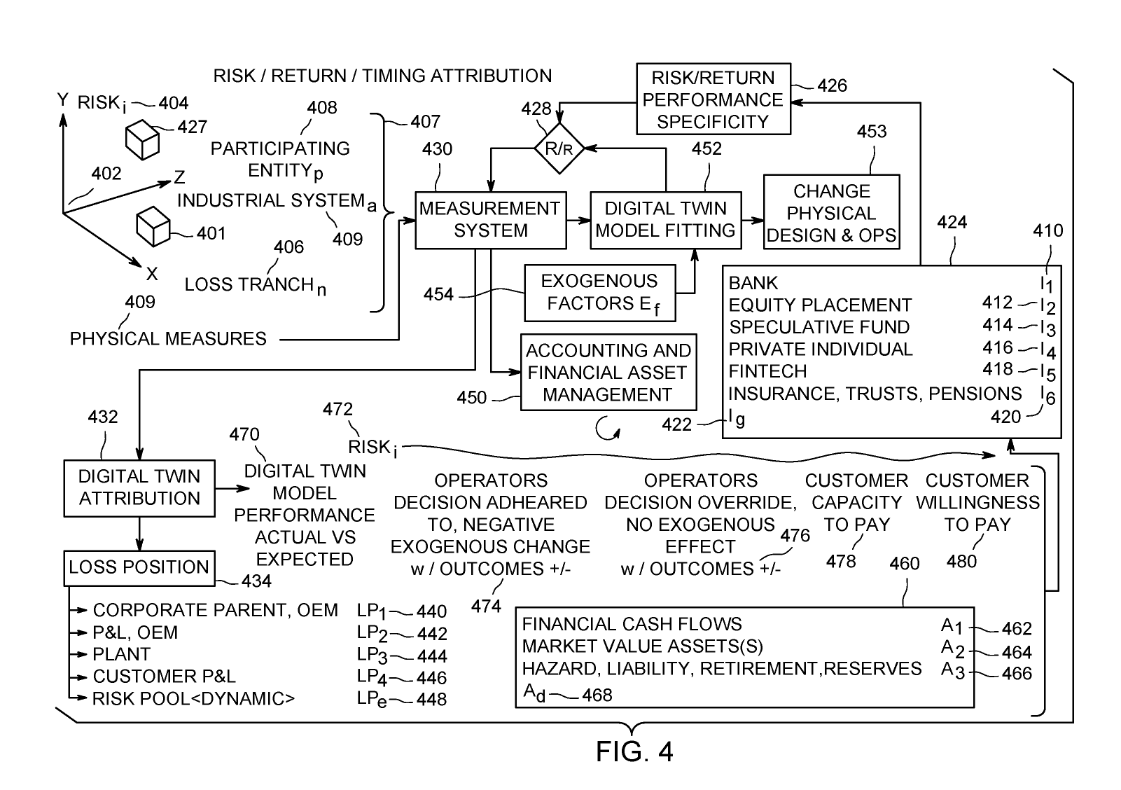

Next, the discussion will turn to FIG. 4. FIG. 4 is concerned with attribution of risks and returns and the timing thereof.

A risk vs. return vs. “responsible entity” space 402 is defined by axes 404 (risks), 406 (losses) and 408 (responsible entity). Investment types 410, 412, 414, 416, 418, 420, 422 are listed in block 424. Specific risk/return parameters (block 426) corresponding to the investment types are fed to a decision block 428. An output from the decision block 428 governs application of measurement systems 430. The measurement systems 430 may include functionality for measuring physical/operating performance, financial performance and risk/reward parsing. Outputs from the measurement systems 430 drive attribution element 432 of the digital twin, leading to loss positions (block 434) attributed among loss positions 440, 442, 444, 446 and 448 (as identified, for example, by labels listed below block 434). Performance attributions by entities (440, 442, 444, 446, 448) occur as a function of the areas in the control system which give rise to certain risks 472, such as from the model's actual versus expected analytical control performance 470, the system operator's decision(s) as informed by the system being followed 474 or not, within bounds of the specified exogenous conditions in which the decision would be feasible using the system, the operator's override of the system's decisioning 476, the customer's ability to pay 478 and the customer's willingness to pay 480. Outputs from the physical-financial measurement systems 430 also guide accounting and financial management 450 and digital twin model fitting 452. Other inputs to digital twin model fitting 452 include exogenous factors 454, such as weather. The digital twin model fitting 452 also serves as an additional input to decision block 428, increasing its fidelity with more accurate models. Various cash-flows and reserves are represented by block 460, which result from the sensing and control of the physical-digital system and stakeholder actions that are taken with or without the benefit of the disclosed system.

Consider the arrangement as described in FIG. 4 with respect to a given performance based contract wherein a providing service provider such as an OEM offers assets and services to another firm for that other firm's use in their commercial activities. The performance based contract has investments at a first time and returns at a later time. And that the capital required to implement industrial system upgrades which in turn fulfil the performance based contract are enabled by a financial entity. The resulting investments and returns are represented by 401, a risk-return-entity that exists in a state space of risk with respect to which investor will bear what risks 406, the level of negative variation from plan 404 and participating entity 408. A given performance contract 318 may have many investors, one or several service providers 305 and within the contract, many different risks 404 in many different loss positions 406. The overarching contract is the sum total weighted average of all the stakeholders, yet the allocation of the investments, performance is disaggregated to the granular states 401 of the participants.

The industrial system that is the object of the performance service being offered is comprised of industrial assets. For example, in a gas turbine power plant, an inlet air system, a fuel system, a turbine, a generator, a heat recovery steam generator, a steam turbine, another generator, a condenser, a cooling circuit, a water plant, an electrical infrastructure. Each of these asset examples separately and severally impact the operating performance of the industrial system. It can be appreciated that these assets are themselves systems of subsystems. For example, a turbine has a compressor section, a combustion system, an expansion turbine, a fuel system, a control system. Further that a subsystem may have components such as nozzles, blades and on those components are elements that enable their operation such as coatings, physical dimensions and material properties. All of these aspects of design and the ultimate operations of the asset(s) are the industrial system 409. State estimation models of physical condition of these is a digital twin. How the asset(s) and their subsystems are operated to achieve operating results is the Digital Twin Operations Optimization. The digital twin modeling system 407, 452 is a virtual representation of the physical system's asset states and the collective design, use and consumption operations. This virtual version of the actual system exists in historical time domain, the current and simulated future domain. The asset models are exercised through the time domain, being exposed to historical, current sensed or hypothetical future conditions and activities. The historical and current time domain is fully revealed and observed. The future time domain is characterized by scenarios and replications where the current physical and operating designs or policies are but one scenario of many that may be tested as scenarios. There are many aspects related to industrial systems which cannot be controlled and thus the industrial system may be caused to operate robustly to a range of these exogenous conditions or, if out of capability to achieve the desired KPIs with a given design or operations mode, may be switched to another design. The performance contract and service provider and financial entity use the digital twin capability 407 to manage risks and value for each participant as outlined in FIG. 4.

It can be appreciated how the sensing, communication, computation of all aspects of physical and financial components must occur in the present as the system controls the apparatus. Any unplanned physical degradation or performance over an interval of time directly effects the operating performance of the system and thus the change in risk for the one or more stakeholders. The computing control system is thus an integrated system fully sensing, modeling, accounting, optimizing and controlling one or more systems of a complex industrial system such as a power plant(s), aircraft engine(s), diagnostic equipment, electrical distribution and control system(s), oil extraction systems, manufacturing system(s), locomotive(s) and similar industrial systems.

In the face of changing exogenous forces and the many design and operating choices available—accountability is managed so that the stakeholders who should act under the terms of the contracts do so and the resulting performance results are attributed. For this purpose, a measurement system 430 exists to allocate performance results to the modeling accuracy, operator choices and exogenous factors. For the resulting cashflows, allocations are enabled.

The central capability being disclosed in FIG. 4 relates to the actual system performance with respect to its forecasted performance and, in instances where the system does not produce the results anticipated by the various tranches of participating entities, where and to whom the under performance is attributed. A set point ratio of risk and return 401 is set at the system level and for each combination of risk 404, loss tranche 406 and responsible entity 408. The sensing system's physical measures 409 along with the attributed financial 407 measures are obtained by the measurement system 430. The “is” is compared to the set points 401. The disclosed physical-financial measurement and control system automatically manages system design modification and operations in such a way as to optimally bring the “is” as close as possible to the risks and returns parsed out amongst the various stakeholders and their tranches. Where performance falls short, the responsibility is allocated to a causal reason.

One source of performance miss is error from the control transfer functions governing the physical and financial response to change 470. In a performance based contract, the service provider, for example and OEM, may warrant the accuracy of the design and operating models of the system and would assume this performance risk 472, 404. If the measured performance 401, 407 does not meet specifications when other conditions are controlled for such as an operator following the provided decision support 474 and the exogenous conditions are within the specified bounds of the model accuracy, then the entity responsible for making the other stakeholders financially whole falls to the OEM. However, there may be another entity 408 who may desire to bear this performance risk in a certain order of exposure tranche 406. Unlikely that a party other than the provider would take on the performance risk of a model, though possible, at a point in time, the risk transfer from the model provider to the new entity willing to take the model performance risk can form the basis of a financial transaction equivalent to the market value of the risk transfer. More likely, the OEM in this case would take a first loss position 406 and purchases a coverage for model error from another party willing to take the exposure for a given cashflow at the time of transaction. In a similar way, any risk 404, 472 for any combination of loss position 406 may be held by any participating entity 408 and the risk/returns 428 as understood by participants 424, 434 may be valued and transacted at any time.

As an example embodiment to further illustrate the invention, we use the case of a power plant which is in operation, being managed by the disclosed measurement and control system. One or more financial investors 424 desire to make a certain return on invested capital, for example, an investor who accessed this system via an internet based banking and investment system, aka “Fintech” 418. The investor is looking for a certain return that is, as an example, 3% above the opportunity cost of capital of the service provider. This investor is not interested in any model risk or operator action risk but is ok with credit risks 478, 480 of the physical system operator 444. The performance contract is offered to the physical system operator by the OEM 440. The disclosed system identifies that an inlet air chiller, if added, will create an economic return that minimally meets that sought by the investor. Capital is moved from the investor 418 to the provider 440 and the chiller is purchased, placed on the balance sheet 450 of the service provider. As the plant 444 is then operated per the disclosed system, the chiller does provide more operating efficiency as measured by the measuring system 430. The returns are allocated to an OEM entity 408, 440 who in turn allocates cashflow to an investing entity 408, 418 according the terms of a contract that allocates risks 404, loss position 406. While the investment initially results in the investor receiving the agreed upon return, in operation, the measured productivity falls below plan over time. It is determined that an exogenous factor 454 range used in the performance model 452 exceeds an operating range tied to the contract. Since the loss attribution is not model error 470, the operator is following the system directives 474 but it is the underlying force, for example a reduced gas price eliminates the benefit of a more efficient plant, the loss is borne by the investor 418. Alternatively, it could be that the operators are violating the prescribed operations 476 and irrespective of the exogenous conditions, the losses would be allocated to the operator 444. That operator may have the ability to pay 478 but choose not to 480—in which case the credit risk is borne by the investor since that was the risk tranche specification.

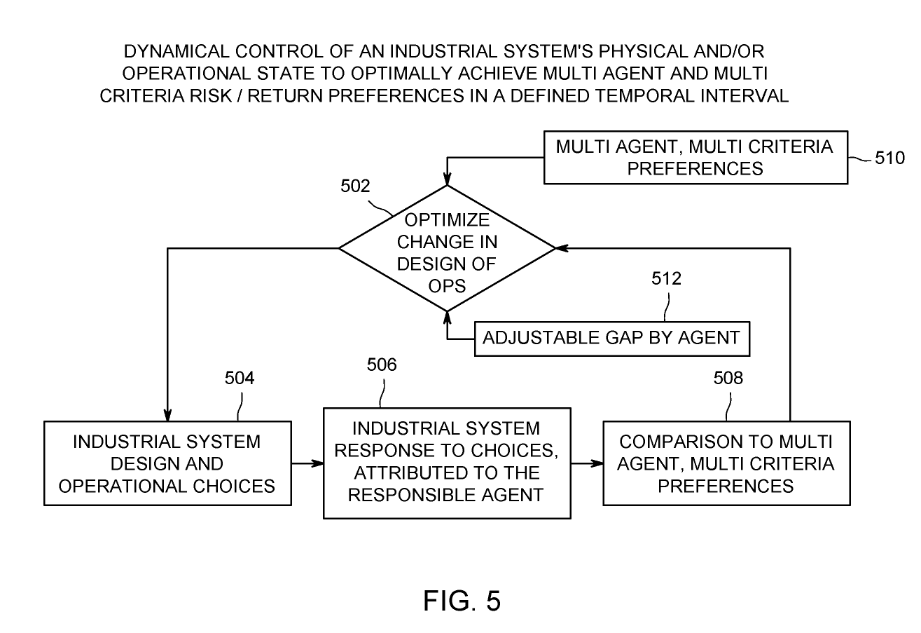

Reference is now made to FIG. 5. FIG. 5 is a high-level flow chart relating to dynamical control of an installed product to satisfy risk/return preferences of a number of parties. Decision block 502 represents optimization of operational design for the installed product. Block 504 represents design/operational choices applied to the installed product. Block 506 represents the installed product's response to the choices made at block 504, as attributed to the responsible party. Block 508 represents a comparison of the responses to the parties' respective preferences. Inputs to the decision block 502 include feedback via block 508; data relating to the parties' preferences, as represented by block 510; and adjustments, as represented by block 512. Although not explicitly shown in the drawing, a participating industrial system may function as an additional decision block in series with block 502.

Extending the example of FIG. 4, the disclosed system enables the participation of many stakeholders with various investment requirements and preferences and allocates performance accordingly while also dynamically measuring and controlling the system to achieve the objectives of the many stakeholders. Consider the two parties, an OEM and an investor seeking a targeted return. These are modeled as agent based entities with preferences 510 (FIG. 5) in the measurement and control system's logic. The investor's return and risk preferences may be available in one industrial system's design (e.g., adding a chiller) and or operations (e.g. when to line up and operate the chiller), or possibly only available in more than one industrial system, perhaps in a plurality that are distributed across domains so as to achieve the financial return and minimize risk, such as, for example, payment risk by diversification among payers. The productivity likewise may be diversified to minimize the effects of a given exogenous condition such as fuel prices. The control system adjusts 512 the participating investments and industrial systems so as to feasibly attain the multiple criteria of many agents and their preferences by construction of the membership related to a given contract as well as the design and operations of one or more given industrial system.

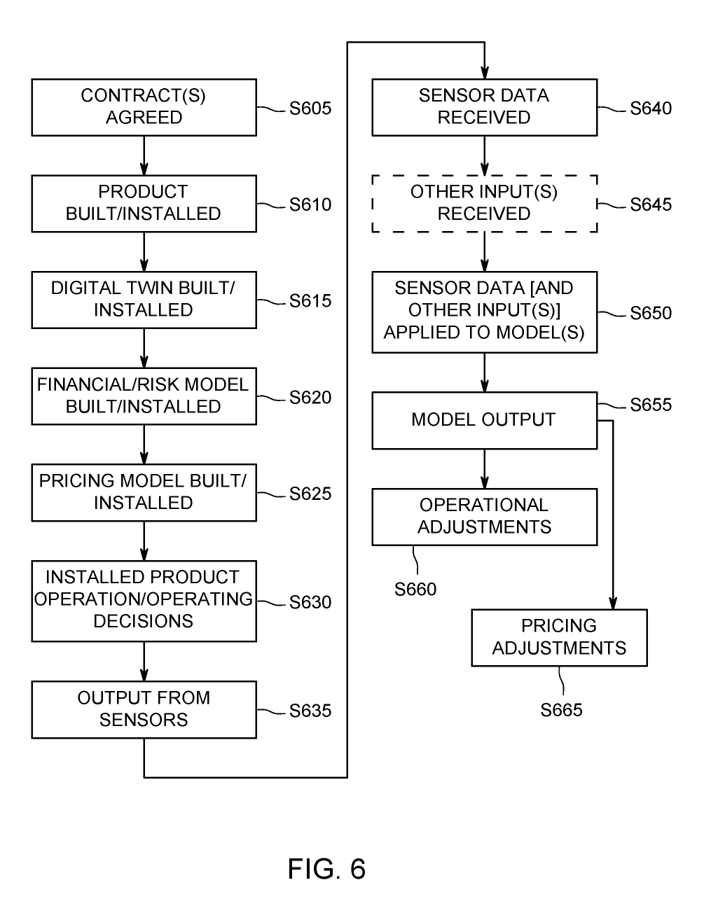

FIG. 6 is a flow diagram of an operation according to some embodiments.

At S605 in FIG. 6, a contract or contracts regarding sale, maintenance, etc. of the installed product 102 are put in place. In some embodiments, the parties to the contracts include at least the proprietor of the installed product (i.e., a party that benefits from operation of the installed product) and the seller of the installed product (i.e., the party that builds the installed product and/or provides some or all maintenance/parts/system management services for the installed product). Contractual relationships with one or more investors may also be established at S605, or thereafter.

At S610 in the FIG. 6, the installed product 102 is built and/or installed.

At S615, the digital twin 117 that models the installed product 102 is built (i.e., written in a suitable programming language) and installed (i.e., loaded/installed in the modeling computer 110). In some embodiments, the creation of the digital twin 117 may occur before the building of the installed product 102 and may even guide the building of the installed product 102; i.e., the digital twin 117, in some embodiments, may serve as part or all of the specifications for building the installed product 102. In other embodiments, after the installed product 102 is built, the digital twin 117 is written to reflect the characteristics and make-up of the installed product 102, as built.

At S620, the economic risk and/or financial model 116 is built (i.e., written in a suitable programming language) and installed (i.e., loaded/installed in the modeling computer 110). The economic risk and/or financial model 116 may reflect the economic/risk allocation consequences of one or more contracts that have been entered into with respect to the installed product 102. The economic risk and/or financial model 116 may reflect one or more costs expected to be incurred in connection with operation of the installed product 102. The economic risk and/or financial model 116 may reflect one or more economic benefits and/or revenue streams expected to be realized by operation of the installed product 102. The economic risk and/or financial model 116 may reflect contingent effects on costs incurred and/or revenue realized from one or more factors, such as operating conditions, exogenous conditions, operating decisions, the extent to which the capacity of the installed product is put into operation, etc.

At S625, the financial entity model 118 is built (i.e., written in a suitable programming language) and installed (i.e., loaded/installed in the modeling computer 110). As noted before, the financial entity model 118 may be included in or overlap with the economic risk and/or financial model 114. The financial entity model 118 may provide functionality for calculating a stream of prices to be paid over time in the future from one party concerned with the installed product 102 to another party concerned with the installed product 102. The pricing functionality may reflect a contractual arrangement that has been put in place between the parties with respect to the installed product 102. The pricing functionality may reflect contingent effects on pricing due to one or more factors, such as operating conditions, exogenous conditions, operating decisions, the extent to which the capacity of the installed product is put into operation, etc.

Both the economic risk and/or financial model 116 and the financial entity model 118 may be programmed to receive one or more inputs from the digital twin 117 to reflect operations and states of all of, or portions of, the installed product 102.

Block S630 represents operation over time of the installed product 102, including operating decisions made with respect to the installed product 102 by the proprietor of the installed product 102.

Block S635 represents output of sensor data over time from the sensors 106 (FIG. 1) incorporated in the installed product 102.

At S640, the modeling computer 110 receives the sensor data via the communication channel(s) 120. The modeling computer 110 may receive other inputs as well (as indicated in phantom at S645). The other inputs may include, for example, various economic indicators that are published over time. The economic indicators may include, for example, short or long term interest rates, prevailing corporate average returns on equity, currency exchange rates, commodities prices, commodities futures prices, stock market indices, market volatility indices, prices of financial derivatives, etc.

At S650, the sensor data received at S640 is applied as input to the digital twin 117. Moreover, if other relevant data is received by the modeling computer 110, such data may be applied as input to either or both of the economic risk and/or financial model 116 and the financial entity model 118.

At S655, the models 117, 116 and/or 118 may provide outputs in response to the inputs that were provided to the models. In some embodiments, outputs from the digital twin 117, indicative of operations and/or conditions relevant to the installed product 102 and/or its components may be applied as inputs to the economic risk and/or financial model 116 and/or the financial entity model 118. One or more outputs from the digital twin 117 may also effect changes or modifications (block S660) with respect to the installed product 102 and/or one or more components thereof Moreover, one or more outputs from the financial entity model 118 may adjust the stream of prices payable from one party to another (as indicated at S665 in FIG. 6). Still further, the modifications (block S660) in operation or modifications to the installed product may also or alternatively stem from output(s) from the economic risk and/or financial model 116.

Some concrete examples will now be presented.

Assume for purposes of a first example that the installed product 102 is a gas-fired electric generating plant. Assume further that it is expected that the generating plant is to serve mainly in the role of a supplementary source of electrical power for times when a number of wind farms are producing less than a currently required level of electrical power. The proprietor of the generating plant may be an electric utility “UtilCo”. Key components of the plant may have been built by a major industrial company (such as the General Electric Company—“GE”—which is the assignee hereof), which sold the plant components to UtilCo, and thus is a seller with respect to the installed product. The seller of the installed product may also have agreed to provide performance based management with respect to the installed product 102. Both the sale of the plant components and the ongoing management services may have been agreed to be performed pursuant to contracts between the parties. The prices to be charged by the seller to the proprietor for the ongoing management services may be variable, depending on a number of factors. The factors may include, how much of the time the proprietor causes the generating plant to be in operation. In some embodiments, the pricing may not be based directly on the amount of operating time by the plant during a time period, but rather may be based on output from the digital twin 117 regarding the effects of operation on the components of the plant.

In this example, if a new windfarm comes online, or the plant proprietor contracts to obtain supplemental power from a source with access to natural gas at a lower price, then the installed product 102 may be operated sparingly. The sensor inputs, as interpreted by the digital twin 117, indicate that the components of the installed product are experiencing less wear than anticipated. Output from the digital twin 117 then causes the financial entity model 118 to adjust downward the pricing for the ongoing system management to be provided by the seller.

Considering another possible scenario under the same example, suppose that a major transmission line for transmitting power from the wind farms suffers severe damage in a natural disaster (or that demand for electricity increases in the areas served by the wind farms). The proprietor of the installed product (i.e., the gas-fired generation plant) determines that it is advisable to operate the installed product a much higher proportion of the time than was anticipated. Sensor data provided to the digital twin 117 reflects this increased use. Output from the digital twin 117 to the economic risk and/or financial model 116 causes the economic risk and/or financial model 116 to provide output that—reflecting the proprietor's risk/return preferences—causes a portion of the installed product to be taken off-line for preventive maintenance 9 months earlier than previously scheduled. At the same time, the financial entity model 118—based on the outputs from the digital twin 117—raises the pricing for the ongoing management services provided by the seller of the installed product 102.

A second example will now be described. According to this example, it is assumed that the installed product 102 is a jet engine installed in a large jet transport aircraft. It is further assumed that the aircraft is operated by a passenger airline “AirX”, which is to be deemed the proprietor of the installed product. The manufacturer of the engine is the seller, and in addition to a sales contract with AirX, the seller has also become contractually bound to provide comprehensive maintenance services according to a schedule that is variable (subject to input from at least one of the models running in the modeling computer 110) and also required to minimize downtime for the aircraft.

Again sensors 106 in the installed product 102 may report conditions of components 104 to the modeling computer 110. The sensors 106 may also include suitable sensors to report air speed, altitude, ambient air temperature, etc. to the modeling computer 110. As before, higher or lower hours of operation of the installed product 102 during a given time period may be reflected in output from the digital twin 117 to the financial entity model 118, and in turn in lower or higher pricing for maintenance according to adjustments based on outputs from the financial entity model 118.

The economic risk and/or financial model 116 may be programmed to distinguish between greater-than-anticipated wear (as reported by the digital twin 117) that is due to operating decisions made by the proprietor, versus greater-than-anticipated wear resulting from characteristics of the installed product as it was manufactured by the seller. The former may result in higher maintenance pricing to the proprietor; the latter may not result in higher pricing.

Continuing to discuss other possible aspects of the jet engine example, the economic risk and/or financial model 116 may allocate exogenous risks between the proprietor and the seller. For example, if a rare material is required for replacement of turbine blades in the engine, and market prices for the rare material increase significantly from a base-case assumed price level, then 70% of the additional cost due to the price increase may be attributed to the proprietor and 30% of the additional cost may be attributed to the seller, according to one embodiment.

In another possible aspect of the jet engine example, due to operating decisions by the proprietor, wear of some components, as indicated by output from the digital twin 117, may be greater than a base-case assumption. Because of the wear, the economic risk and/or financial model 116 may indicate that the aircraft should be scheduled for or held for 12 extra hours at a hub airport where the seller has a maintenance facility. Replacement of some components of the installed product 102 may be done during that time interval, to reduce the risk of a further and longer unplanned downtime episode for the aircraft.

With a financial entity model operating as in the two examples described above (or in other embodiments), with input from the digital twin, it may be feasible for the seller to quote initially lower maintenance/system management pricing than would be required in conventional situations in which the seller is potentially exposed to unexpected costs arising from variations in operating ratios or conditions. The pricing model may also provide some measure of control to the proprietor as to whether additional costs will be incurred vis a vis the seller. More generally, modeling as described herein may support increased flexibility in allocation of risks and rates of return among parties, including the proprietor, the seller, and one or more other parties such as financing sources, an equipment lessor, etc.

It will be appreciated that other types of shifting or allocations of costs and/or risks may be provided for by suitable modeling (reflecting contractual relationships), either for the types of installed products included in the examples or for other types of installed products.

In some embodiments, output from either or both of the digital twin 117 and the economic risk and/or financial model 116 may result in actions to be taken with respect to or within the seller's (or proprietor's) supply chain, so that replacement parts and/or other materials or resources are rescheduled for delivery according to the model outputs.

Computer 700 shown in FIG. 7 is an example hardware-oriented representation of the modeling computer 110 shown in FIG. 1. Continuing to refer to FIG. 7, computer 700 includes one or more processors 710 operatively coupled to communication device 720, data storage device 730, one or more input devices 740, one or more output devices 750 and memory 760. Communication device 720 may facilitate communication with external devices, such as a reporting client, or a data storage device. Input device(s) 740 may include, for example, a keyboard, a keypad, a mouse or other pointing device, a microphone, knob or a switch, an infra-red (IR) port, a docking station, and/or a touch screen. Input device(s) 740 may be used, for example, to enter information into the computer 700. Output device(s) 750 may include, for example, a display (e.g., a display screen) a speaker, and/or a printer.

Data storage device 730 may include any appropriate persistent storage device, including combinations of magnetic storage devices (e.g., magnetic tape, hard disk drives and flash memory), optical storage devices, Read Only Memory (ROM) devices, etc., while memory 760 may include Random Access Memory (RAM).

Data storage device 730 may store software programs that include program code executed by processor(s) 710 to cause computer 700 to perform any one or more of the processes described herein. Embodiments are not limited to execution of these processes by a single apparatus. For example, the data storage device 730 may store a program 732 that provides an interface to receive and provide initial processing with respect to the sensor data provided from the sensors 106 depicted in FIG. 1.

Continuing to refer to FIG. 7, data storage device 730 may also store a software program 734, which may correspond to the digital twin 117 referred to above.

In addition, data storage device 730 may store a software program 736, which may correspond to the economic risk and/or financial model 116 referred to above.

Still further, data storage device 730 may store a software program 738 which may correspond to the financial entity model 118 referred to above.

Also, data storage device 730 may store a database manager program 742 and a database 744, which may support operation of the models stored and running in computer 700. Data storage device 730 may store other data and other program code for providing additional functionality and/or which are necessary for operation of system computer 700, such as device drivers, operating system files, etc.

In some embodiments, some or all obligations to or among stakeholders may be denominated and settled in one or more currencies issued by a central bank. In some embodiments, some or all obligations to or among stakeholders may be denominated and settled in one or more cryptocurrencies. (“Cryptocurrency” has been defined as a digital currency in which encryption techniques are used to regulate the generation of units of currency and verify the transfer of funds, operating independently of a central bank.) Accordingly, in some embodiments, settlement of obligations to stakeholders may occur via cryptocurrency transactions.

A technical effect is to provide improved efficiency and flexibility in operation of complex mechanical systems.

The foregoing diagrams represent logical architectures for describing processes according to some embodiments, and actual implementations may include more or different components arranged in other manners. Other topologies may be used in conjunction with other embodiments. Moreover, each system described herein may be implemented by any number of devices in communication via any number of other public and/or private networks. Two or more of such computing devices may be located remote from one another and may communicate with one another via any known manner of network(s) and/or a dedicated connection. Each device may include any number of hardware and/or software elements suitable to provide the functions described herein as well as any other functions. For example, any computing device used in an implementation of some embodiments may include a processor to execute program code such that the computing device operates as described herein.

All systems and processes discussed herein may be embodied in program code stored on one or more non-transitory computer-readable media. Such media may include, for example, a floppy disk, a CD-ROM, a DVD-ROM, a Flash drive, magnetic tape, and solid state Random Access Memory (RAM) or Read Only Memory (ROM) storage units. Embodiments are therefore not limited to any specific combination of hardware and software.

The flow charts and descriptions thereof herein should not be understood to prescribe a fixed order of performing the method steps described therein. Rather the method steps may be performed in any order that is practicable, including simultaneous performance of steps.

Embodiments described herein are solely for the purpose of illustration. A person of ordinary skill in the relevant art may recognize other embodiments may be practiced with modifications and alterations to that described above.

What is claimed is:

1. An apparatus for controlling an operational system having mechanical components, the apparatus comprising:
an installed product, including a plurality of said mechanical components, at least some of the mechanical components each having at least one sensor associated with and/or installed on said each mechanical component;
a computer programmed with an operational optimization model for the installed product, the operational optimization model for modeling at least the mechanical components and the sensors; the computer further programmed with a probability estimation model, said probability estimation model for providing an estimate of a difference measure related to input and output of the installed product; and
at least one communication channel for supplying sensor data from the sensors to the computer;
the computer including a processor and a memory in communication with the processor, the memory storing said operational optimization model and said probability estimation model; the memory storing additional program instructions, the processor operative with the additional program instructions to perform functions as follows:
receiving sensor data generated by the sensors during operation of the installed product;
generating output from the operational optimization model based on the received sensor data and operating performance criteria of one or more stakeholders for one or more subsystems of the installed product, said output from the operational optimization model being a first model output;
generating second model output from the probability estimation model based at least in part on the first model output; and
modifying at least one of said mechanical components of the installed product based at least in part on the second model output.

2. The apparatus of claim 1, wherein said operational optimization model includes a digital twin of the installed product.

3. The apparatus of claim 1, wherein the modification of the at least one mechanical component is based on the first output together with the second output.

4. The apparatus of claim 1, wherein the installed product is a jet engine.

5. The apparatus of claim 1, wherein the installed product is an electrical power generation plant.

6. The apparatus of claim 1, wherein the processor is further operative with the additional program instructions to arrange a cryptocurrency transaction to settle an obligation to one of the stakeholders

7. A method of controlling an operational system, the operational system including an installed product, the installed product including a plurality of mechanical components, the method comprising:
providing the installed product, at least some of the mechanical components each having at least one sensor associated with and/or installed on said each mechanical component;
programming a computer with an operational optimization model for the installed product, the operational optimization model for modeling at least the mechanical components and the sensors;
programming the computer with a probability estimation model, said probability estimation model for providing an estimate of a difference measure related to input and output of the installed product, said probability estimation model responsive to output from the operational optimization model;
receiving sensor data generated by the sensors during operation of the installed product;
generating said output from the operational optimization model based on the received sensor data, said output being first output;
generating second output from the probability estimation model based at least in part on the first output; and
modifying at least one of said mechanical components of the installed product based at least in part on the second output.

8. The method of claim 7, wherein said operational optimization model includes a digital twin of the installed product.

9. The method of claim 7, wherein the modification of the at least one mechanical component is based on the first output together with the second output.

10. The method of claim 7, wherein the installed product is a jet engine.

11. The method of claim 7, wherein the installed product is an electrical power generation plant.

12. A method of operating an installed product, the method comprising:
providing the installed product, said installed product including a plurality of mechanical components, at least some of the mechanical components each having at least one sensor associated with and/or installed on said each mechanical component;
programming a computer with an operational optimization model for the installed product, the operational optimization model for modeling at least the mechanical components and the sensors;
programming the computer with an economic risk and/or financial model responsive to output from the operational optimization model;
receiving sensor data generated by the sensors during operation of the installed product;
generating said output from the operational optimization model based on the received sensor data, said output being first output;
generating second output from the economic risk and/or financial model based at least in part on the first output; and
modifying at least one of said mechanical components of the installed product based at least in part on the second output.

13. The method of claim 12, wherein the economic risk and/or financial model has a plurality of objective inputs apart from the first output, the plurality of objective inputs including at least one respective financial and/or risk objective corresponding to each of a plurality of stakeholders associated with the installed plant.

14. The method of claim 13, wherein the plurality of stakeholders includes at least one of (a) an investor in results of operation of the installed product; (b) a proprietor of the installed product; (c) a seller of the installed product; and (d) a service provider responsible for providing maintenance and/or upgrade services with respect to the installed product.

15. The method of claim 14, wherein the plurality of stakeholders includes a plurality of investors in results of operation of the installed product.

16. The method of claim 15, further comprising:
settling an obligation to one of the stakeholders via a cryptocurrency transaction.

17. The method of claim 12, wherein the installed product is a jet engine.

18. The method of claim 12, wherein the installed product is an electrical power generation plant.

19. The method of claim 12, wherein said at least one sensor includes at least 1,000 sensors, said sensor data including outputs from all of said at least 1,000 sensors.

20. The method of claim 12, wherein said operational optimization model includes a digital twin of the installed product, its operational response, its physical state change response and an operating performance allocation of subsystems of the installed product to stakeholders.

21. An industrial system control apparatus comprising:
an installed product, including a plurality of mechanical components, at least some of the mechanical components each having at least one sensor associated with and/or installed on said each mechanical component;
a computer programmed with an operational optimization model for the installed product, the operational optimization model for modeling at least the mechanical components and the sensors; the computer further programmed with an economic risk and/or financial model responsive to output from the operational optimization model;
at least one communication channel for supplying the sensor data from the sensors to the computer;
the computer including a processor and a memory in communication with the processor, the memory storing said operational optimization model and said economic risk and/or financial model; the memory storing additional program instructions, the processor operative with the additional program instructions to perform functions as follows:
receiving sensor data generated by the sensors during operation of the installed product;
generating said output from the operational optimization model based on the received sensor data, said output being first output;
generating second output from the economic risk and/or financial model based at least in part on the first output; and
modifying at least one of said mechanical components of the installed product based at least in part on the second output.

22. The apparatus of claim 21, wherein the modification of the at least one mechanical component is based on the first output together with the second output.

23. The apparatus of claim 21, wherein the installed product is a jet engine.

24. The apparatus of claim 21, wherein the installed product is an electrical power generation plant.

25. The apparatus of claim 21, wherein said operational optimization model includes a digital twin of the installed product.

26. The apparatus of claim 21, wherein the processor is further operative to arrange a cryptocurrency transaction to settle an obligation to a stakeholder in the installed product.

27. A method of interpreting sensor data to generate a dynamic pricing outcome, the method comprising:
providing an installed product, which includes a plurality of mechanical components, at least some of the mechanical components each having at least one sensor associated with and/or installed on said each mechanical component;
programming a computer with an operational optimization model for the installed product, the operational optimization model for modeling at least the mechanical components and the sensors;
associating an ongoing pricing model with the operational optimization model, the ongoing pricing model for setting a stream of prices payable over time from a proprietor of the installed product to a seller of the installed product, the ongoing pricing model programmed in the computer;
receiving said sensor data, said sensor data generated by the sensors during operation of the installed product; and
providing the received sensor data as inputs to at least one of the operational optimization model and the ongoing pricing model such that at least the ongoing pricing model is adjusted in response to said inputs to change said stream of prices.

28. The method of claim 27, wherein:
said inputs are sensor inputs; and
the ongoing pricing model has additional inputs in addition to the sensor inputs, the additional inputs including at least one economic indicator publicly reported over time.

29. The method of claim 27, wherein the sensor data is affected by operating decisions made by the proprietor of the installed product.

30. The method of claim 27, wherein the installed product is a jet engine.

31. The method of claim 27, wherein the installed product is an electrical power generation plant.

32. The method of claim 27, wherein said operational optimization model includes a digital twin of the installed product.

33. The method of claim 27, wherein said stream of prices includes prices denominated in a cryptocurrency.
